(19) United States
(12) Patent Application Publication
(10) Pub. No.: US 2015/0339115 A1
(43) Pub. Date: Nov. 26, 2015

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventors: Norihiro Kawahara, Kawasaki-shi (JP); Ayumu Wada, Fujisawa-shi (JP); Kazuhiro Monden, Inagi-shi (JP)

(21) Appl. No.: 14/719,020

(22) Filed: May 21, 2015

(30) Foreign Application Priority Data
May 26, 2014 (JP) 2014-108244

(51) Int. Cl. G06F 9/445; H04L 29/08

(52) U.S. Cl. CPC G06F 8/65; H04L 67/10

(57) ABSTRACT

A method for controlling an information processing apparatus which is capable of communicating with a plurality of projectors through a network and which stores a projection program includes obtaining version information of a projection program stored in at least one of the projectors connected to the network, and determining a projection program included in one of the projectors connected to the network so as to update the projection program stored in the information processing apparatus in accordance with the obtained version information and version information of the projection program stored in the information processing apparatus.

### BACKGROUND OF THE INVENTION

1. Field of the Invention

The present invention relates to an image transfer system in which an information processing apparatus and a display apparatus which displays an image supplied from the information processing apparatus are connected to each other through a network.

The present invention further relates to a display apparatus capable of communicating with an external apparatus, a method for controlling the display apparatus, and a program.

2. Description of the Related Art

In recent years, an image transfer system in which personal computers (hereinafter referred to as “PCs”) and projectors are connected to one another through a network has been paid attention.

In such an image transfer system, a function of simultaneously projecting an image in a certain PC by a plurality of projectors, a function of performing display of images in a plurality of PCs by a single projector in multiscreen layout, and the like are realized.

Moreover, a network group (hereinafter referred to as a “session”) may be established by a plurality of PCs and a plurality of projectors, and images in the PCs may be displayed by projecting the images by the projectors in arbitrary layout.

In a case where a session is established between at least one PC and at least one projector as described above, the PC and the projector are required to be capable of performing mutual communication. A technique for realizing establishment of such a session is disclosed in Japanese Patent Laid-Open No. 10-41940. In Japanese Patent Laid-Open No. 10-41940, session information is managed by a plurality of information terminals so that all the terminals are capable of communicating with one another.

However, in a case where an application of an old version has been installed in a PC and an application of a new version has been installed in a projector, for example, in an image transfer system, a new function which may be realized by the projector is not used in the PC.

### SUMMARY OF THE INVENTION

The present invention provides an information processing apparatus capable of communicating with a plurality of projectors through a network. The information processing apparatus includes a storage unit configured to store a projection program used to control a projection process performed by the projectors through the network, a first obtaining unit configured to obtain version information of a projection program stored in at least one of the projectors connected to the network, and a determination unit configured to determine a projection program included in one of the projectors connected to the network so as to update the projection program stored in the storage unit in accordance with the version information obtained by the first obtaining unit and version information of the projection program stored in the storage unit.

Further features of the present invention will become apparent from the following description of exemplary embodiments with reference to the attached drawings.

### BRIEF DESCRIPTION OF THE DRAWINGS

FIG. 1 is a diagram illustrating a main configuration of a PC.

FIG. 2 is a diagram illustrating a main configuration of a projector.

FIG. 3 is a diagram illustrating a configuration of an image transfer system.

FIG. 4A is a flowchart illustrating a process performed by the PC according to the first embodiment.

FIG. 4B is a flowchart illustrating a process performed by a PC according to a second embodiment.

FIG. 4C is a flowchart illustrating a process performed by a PC according to a third embodiment.

FIG. 5 is a flowchart illustrating a process performed by a projector according to the second embodiment.

FIGS. 6A and 6B are concept diagrams illustrating session states of the image transfer system.

FIG. 7 is a diagram illustrating a communication sequence of the image transfer system.

FIGS. 8A to 8H are diagrams illustrating outline of UIs displayed in the PC.

FIGS. 9A to 9D are diagrams illustrating packet configurations representing configurations of various commands transmitted and received between the PC and the projector.

### DESCRIPTION OF THE EMBODIMENTS

Hereinafter, embodiments of the present invention will be described with reference to the accompanying drawings.

### First Embodiment

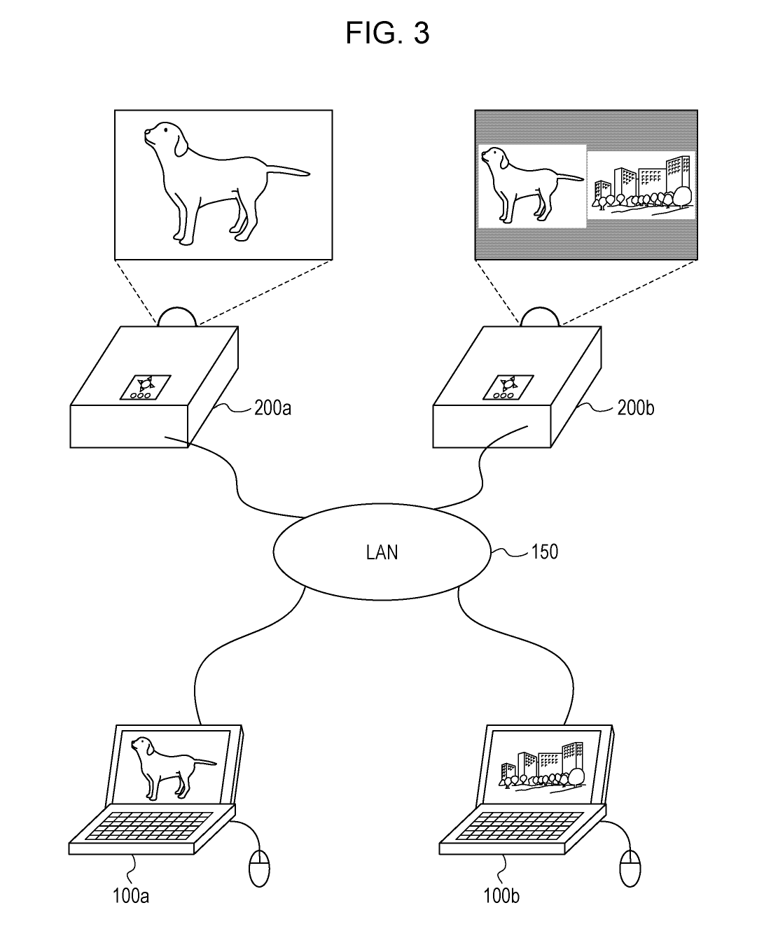

FIG. 3 is a diagram illustrating a configuration of an image transfer system according to a first embodiment.

In the image transfer system, two PCs 100a and 100b which are examples of an information processing apparatus are connected to two projectors (PJs) 200a and 200b which are examples of a display apparatus through a network 150. The PCs 100a and 100b may capture images being displayed in respective displays and transmit the captured images as image data to the projectors 200a and 200b connected through the network 150. On the other hand, the projectors 200a and 200b may receive the image data from the PCs 100a and 100b and project the image data. As illustrated in FIG. 3, projection display in arbitrary layout may be performed such that the image in the PC 100a is projected by the projector 200a and simultaneously the images in the PCs 100a and 100b are projected by the projector 200b by dual-screen layout, for example. A projection method is not limited to that illustrated in FIG. 3. As a first example of the projection method, a single PC performs multicast transmission of an image being displayed to a plurality of projectors. In this case, the plurality of projectors project the same image. As a second example, a single image supplied from a PC is projected by a plurality of projectors in a sharing manner. In this method, a PC transmits the single image to the plurality of projectors and transmits projection regions for individual projectors to the corresponding projectors, and each of the projectors projects a corresponding one of the projection regions in the image received by the projector.

As described above, this embodiment is applicable to a system configured by combining at least one projector and at least one PC. In this embodiment, control is performed such that a network group (hereinafter referred to as a “session”) is configured by at least one PC and at least one projector and a screen of the PC is projected by the projector. For example, a selection of a PC which transmits an image, a selection of a projector which projects the image, projection layout, and the like are controlled. Various control modes may be executed. As a first example, a mode in which each of a plurality of PCs has authority for controlling a plurality of projectors may be executed. As a second example, a mode in which only a specific one of a plurality of PCs has authority for controlling a plurality of projectors may be executed.

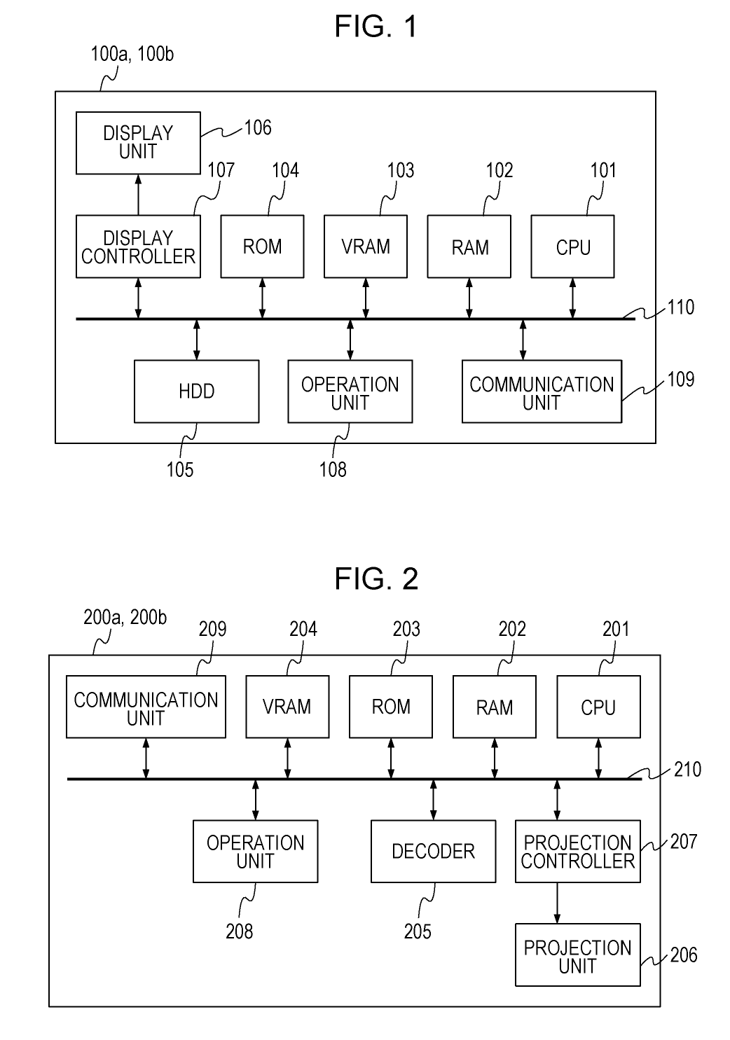

Hereinafter, referring to FIGS. 1 and 2, main configurations of the PCs 100a and 100b and the projectors 200a and 200b included in the image transfer system according to this embodiment will be described. After the description of the configurations, basic operations will be described.

First, a main configuration of the PCs 100a and 100b will be described with reference to FIG. 1. Note that, although a PC is illustrated in this embodiment, this embodiment is applicable to various communication apparatuses such as cellular phones, tablet devices, and digital still cameras.

A central processing unit 101 (hereinafter referred to as a “CPU”) controls the entire PC.

A RAM 102 is a main memory which stores data. The RAM 102 is mainly used as a storage region for storing various data, such as a region for storing or developing programs to be executed by the CPU 101, a work region for a program being executed, and the like.

A VRAM 103 is used as a region for storing image data to be displayed in a display unit 106 which will be described hereinafter. If a speed of the RAM 102 is sufficiently high, the VRAM 103 may be the same as the RAM 102.

A ROM 104 stores a boot program to be executed when the CPU 101 performs initialization. When the boot program is executed, a process of activating an OS recorded in a hard disk drive (HDD) 105 described below by developing the OS in the RAM 102 is performed. In this embodiment, an application for graphical user interfaced (hereinafter referred to as a “GUI application”) which is a program for images is also stored in the ROM 104.

The HDD 105 is used to store various programs, such as application programs and the OS, and data.

A display unit 106 displays an image specified by a display controller 107 described below. The display unit 106 is constituted by a liquid crystal panel, an organic EL panel, or the like.

The display controller 107 performs a process of reading an image stored in the VRAM 103 and displaying the image in the display unit 106.

An operation unit 108 accepts inputs performed by a user. The operation unit 108 includes a keyboard, a mouse, a touch panel, and the like, and input operations performed on the operation unit 108 are transmitted to the CPU 101.

A communication unit 109 communicates with an external apparatus, that is, the projectors 200a and 200b, through the network 150. The communication unit 109 is constituted by an interface, such as a 1-gigabit Ethernet (registered trademark), for example. A communication method is not particularly limited and a wireless LAN may be used, for example.

An internal bus 110 connects the processing blocks described above to one another.

As a basic operation of the PCs 100a and 100b according to this embodiment, a program operated in the CPU 101 controls the display controller 107 and captures data of an image being displayed in the display unit 106. Furthermore, the PCs 100a and 100b encode the captured image data in a predetermined format recognizable by the projectors 200a and 200b, and thereafter, the communication unit 109 transmits the image data to the projectors 200a and 200b which display the image data. When multiscreen layout display is performed by the projector 200b as illustrated in FIG. 3, a resizing process may be performed before the encoding process.

Note that various instructions, such as an instruction for selecting a projector to be communicated, an instruction for setting layout of projection, and an instruction for starting or stopping image transfer, are issued by the user using a graphical user interface (GUI) provided by the program.

Next, a main configuration of the projectors 200a and 200b will be described with reference to FIG. 2. Note that, although a projector is illustrated in this embodiment, this embodiment is applicable to various output apparatuses, such as television sets, set top boxes, and tablet devices.

A CPU 201 controls the entire projector.

A RAM 202 is a main memory which stores data. The RAM 202 is mainly used as a storage region for storing various data, such as a region for storing or developing programs to be executed by the CPU 201, a work region for a program being executed, and the like.

A ROM 203 stores data written therein, such as programs and parameters, used to operate the projector in advance. The CPU 201 operates in accordance with content of the ROM 203. In this embodiment, a GUI application which is a program for images is stored in the ROM 203.

A VRAM 204 is used as a region for storing image data to be projected by a projection unit 206 which will be described hereinafter.

A decoder 205 decodes, when image data supplied from the PCs 100a and 100b is encoded by an encoding method, such as Jpeg, the image data.

The projection unit 206 displays an image specified by a projection controller 207 which will be described below. The projection unit 206 includes a liquid crystal panel, a lens, and a light source, for example.

The projection controller 207 performs a process of reading an image stored in the VRAM 204 and projecting the image by the projection unit 206.

An operation unit 208 receives inputs performed by the user. The operation unit 208 includes buttons disposed on a housing, a remote control receiver which receives user's operations performed by a remote control, not illustrated, and the like, and the input operations are transmitted to the CPU 201.

A communication unit 209 communicates with an external apparatus, that is, the PCs 100a and 100b, through the network 150. The communication unit 209 is constituted by an interface, such as a 1-gigabit Ethernet.

An internal bus 210 connects the processing blocks described above to one another.

As a basic operation of the projectors 200a and 200b according to this embodiment, the projectors 200a and 200b receive image data supplied from the PCs 100a and 100b through the communication unit 209, develop the image data to be displayable by the decoder 205, and thereafter, control the projection controller 207 so as to perform projection display. When the multiscreen layout display is to be performed by the projector 200b as illustrated in FIG. 3, the multiscreen layout display is realized by determining destinations of storage of results of decoding of image data supplied from a plurality of PCs to addresses in the VRAM 204 taking display positions of PC images into consideration.

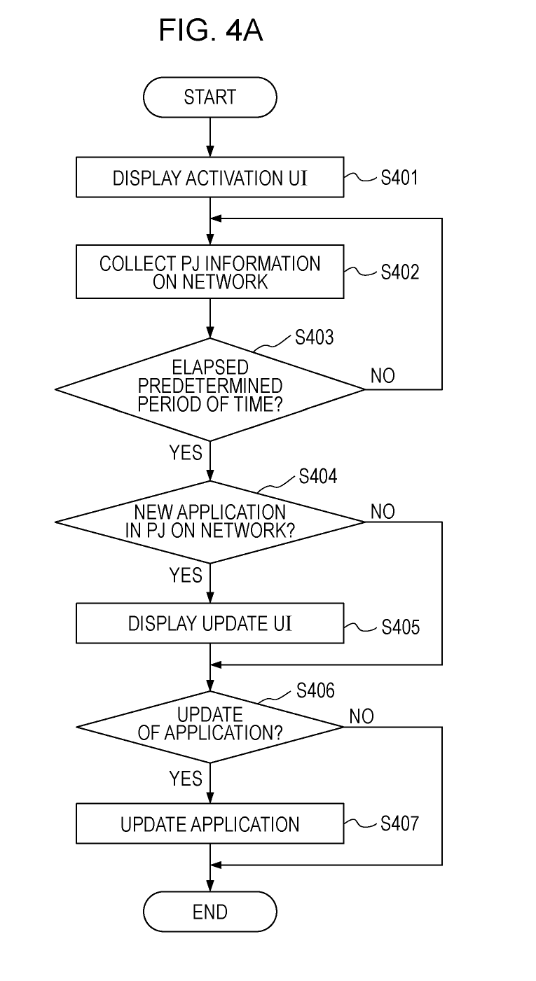

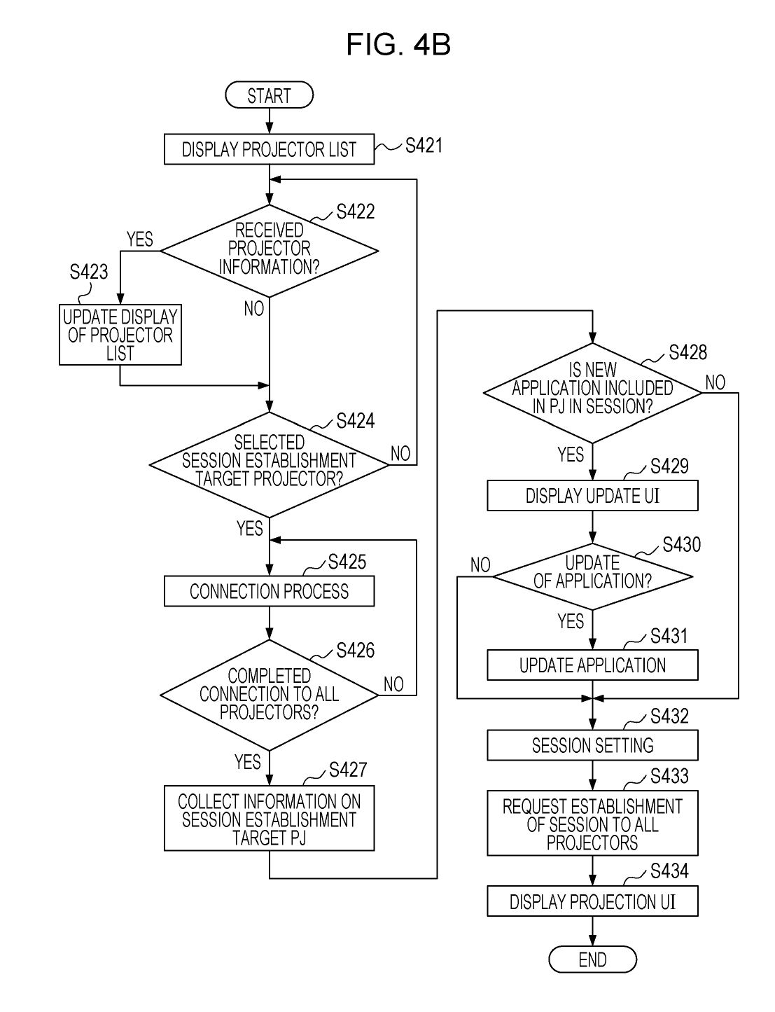

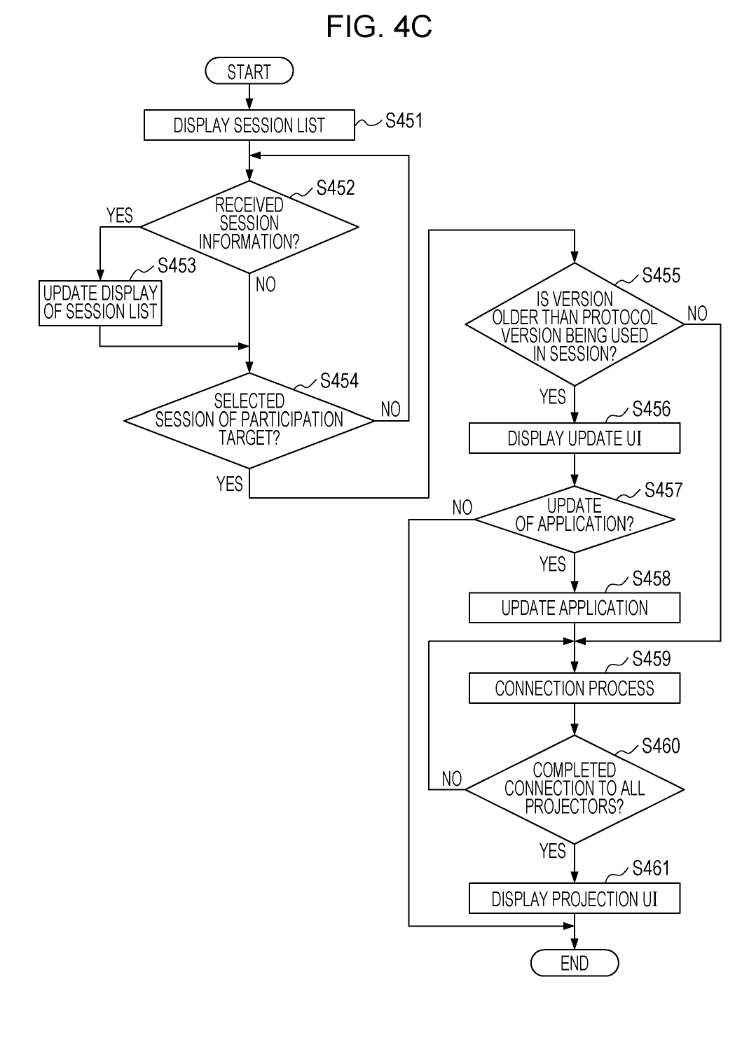

FIG. 4A is a flowchart illustrating a process performed by the PC according to the first embodiment. When a GUI application is activated in the PC 100a, for example, the process illustrated in FIG. 4A is started in response to an instruction issued by the CPU 101.

In step S401, the CPU 101 displays a screen, not illustrated, representing the activation of the GUI application.

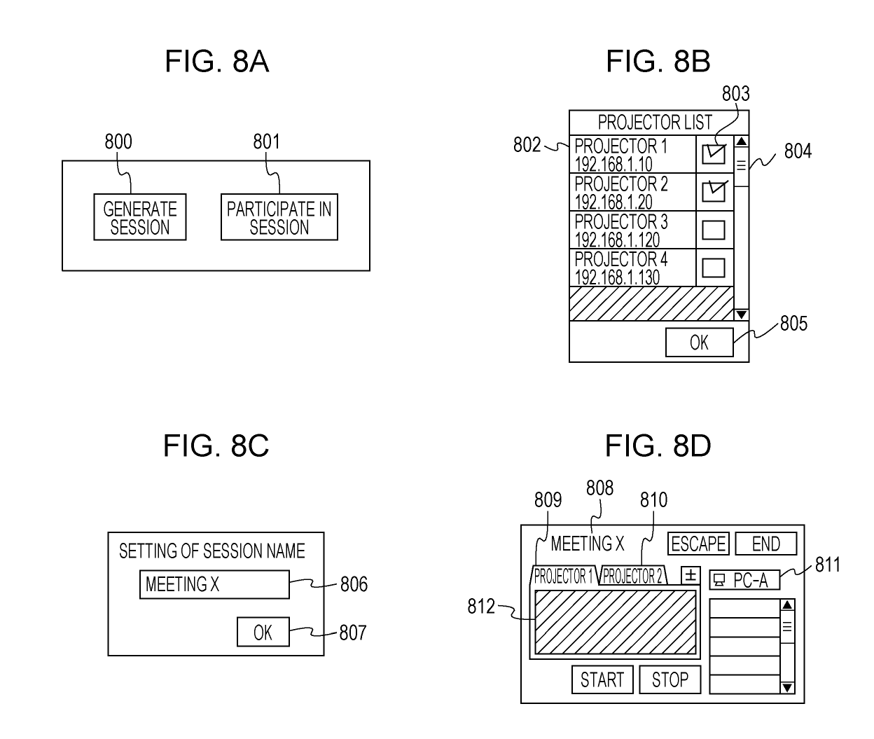

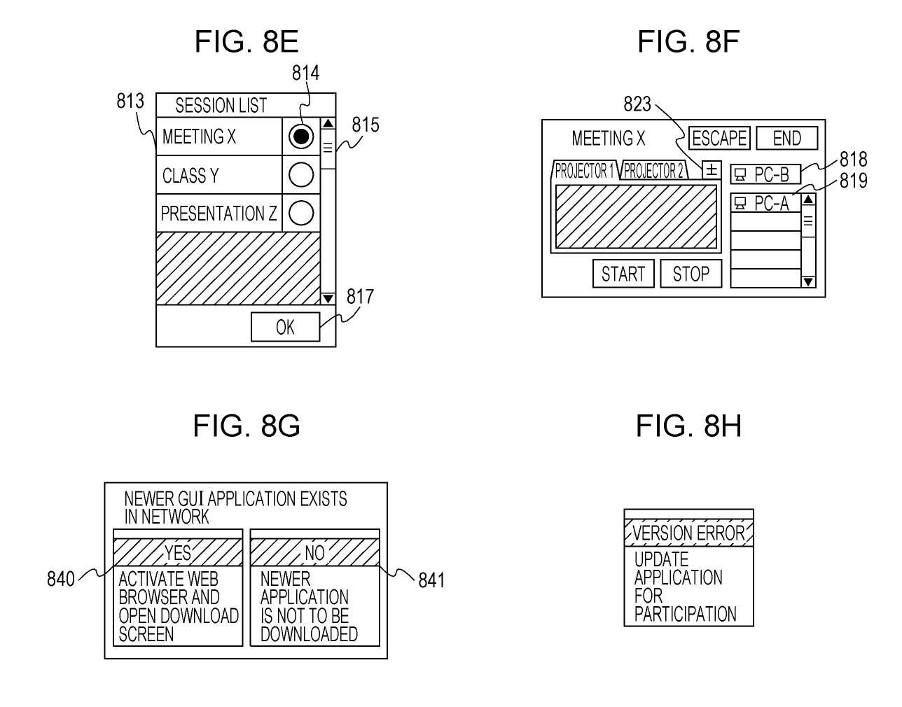

In step S402, the CPU 101 receives projector information commands periodically issued by projectors included in a subnetwork so as to collect information. Here, a projector list UI illustrated in FIG. 8B is displayed. The projector list UI includes a region 802 for displaying a list of the projectors from which information is obtained.

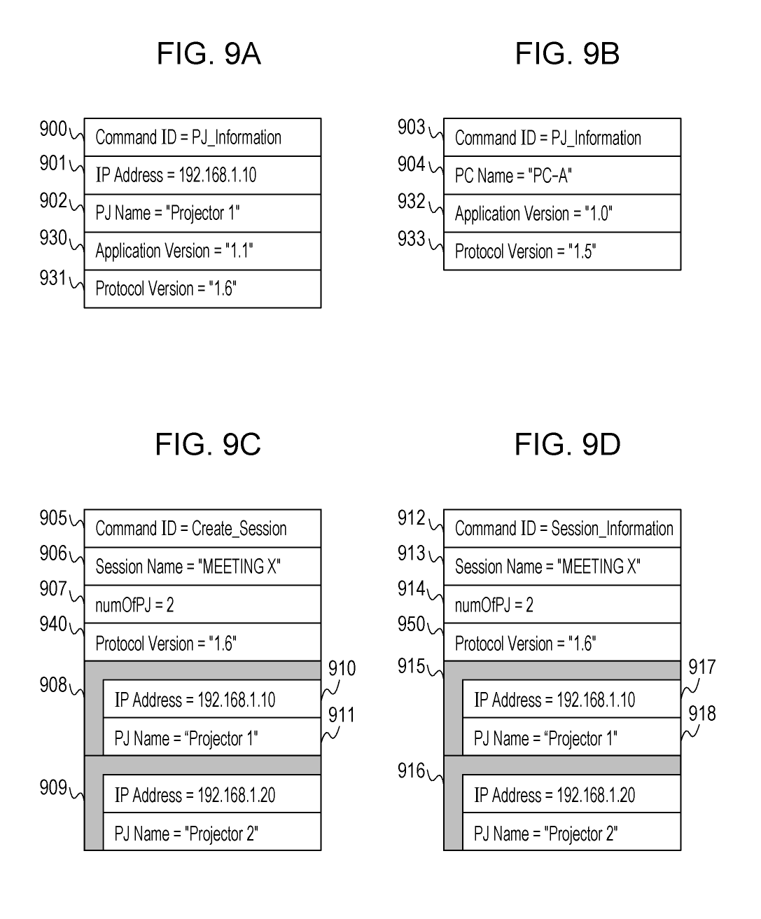

FIG. 9A is a diagram illustrating a packet configuration of the projector information commands.

A command ID tag 900 represents that the command is the projector information command.

An IP address tag 901 represents an IP address of a projector which has issued the command of interest.

A PJ name tag 902 represents a projector name set to the projector of interest.

An application version tag 930 represents a version of a GUI application stored in the projector of interest.

A protocol version tag 931 represents a version of a communication protocol.

FIG. 9B is a diagram illustrating a packet configuration of a PC information command.

A command ID tag 903 represents that the command is the PC information command.

A PC name tag 904 represents a name assigned to the PC.

An application version tag 932 represents a version of the GUI application stored in the PC.

A protocol version tag 933 represents a version of a communication protocol.

Referring back to FIG. 4A, in step S403, the CPU 101 measures time using a timer, not illustrated, so as to collect projector information commands in the subnetwork for a predetermined period of time (approximately 2 seconds, for example). When a projector is newly detected, the number of projectors included in the list displayed in the region 802 is increased. In step S404, the CPU 101 compares a version of the GUI application which executes this processing flow with versions of GUI applications of the projectors collected in step S402. As a result, when it is determined that at least one of the projectors stores a GUI application of a version newer than the version of the GUI application being executed by the PC 100a, the process proceeds to step S405 where a UI for update of the GUI application illustrated in FIG. 8G is displayed.

In the example illustrated in FIGS. 9A and 9B, a version of a GUI application of a projector in the tag 930 included in the packet supplied from the projector is 1.1 whereas a version of a GUI application of the PC 100a stored in the ROM 104 is 1.0. Therefore, it is determined that the version of the GUI application of the projector is newer.

In FIG. 8G, when selecting the update of the GUI application, the user presses a button 840 and otherwise presses a button 841.

In step S406, the CPU 101 determines whether an instruction for updating the GUI application has been issued using the UI for updating a GUI application illustrated in FIG. 8G. When the instruction for updating the GUI application is issued since the button 840 is presses, the process proceeds to step S407. When the instruction for updating a GUI application is not issued since the button 841 is pressed, the process is terminated.

In step S407, the CPU 101 downloads the GUI application of the newer version retrieved in step S404 from the projector which stores the GUI application through the network 150 and the communication unit 109 and stores the GUI application in the RAM 102.

In a case where a plurality of projectors store GUI applications of newer versions, one of the GUI applications included in one of the projectors which is in a top of the list in the region 802 of FIG. 8B may be downloaded. The downloading method is not limited to this, and a GUI application may be downloaded from a projector which is detected first or a projector selected by the user from the list in the region 802.

Furthermore, although, when a version of a GUI application of a PC of interest is older than a version of a GUI application of a projector, the GUI application of the projector having the newer version is downloaded in this embodiment, the downloading method is not limited to this. When a version of a communication protocol described in the protocol version tag 933 is older than a version of a communication protocol described in the protocol version tag 931, a GUI application may be downloaded from a projector having the communication protocol of the newer version. In this way, the GUI application may be updated only when communication protocols between the PC and the projector are different from each other.

As described above, in the image transfer system, when a GUI application of a newer version is detected in a projector which is a transfer destination, the user is prompted to update a GUI application of a PC. By this, the user is not required to check consistency between a GUI application and a projector number and may use a new function of the GUI application by a simple operation.

### Second Embodiment

A second embodiment is different from the first embodiment in that when a projector of a session establishment target stores a GUI application of a newer version, the user is prompted to update a GUI application at a time of generation of a session. Configurations of an image transfer system, PCs, and projectors are the same as those of the first embodiment, and portions different from the first embodiment are mainly described hereinafter.

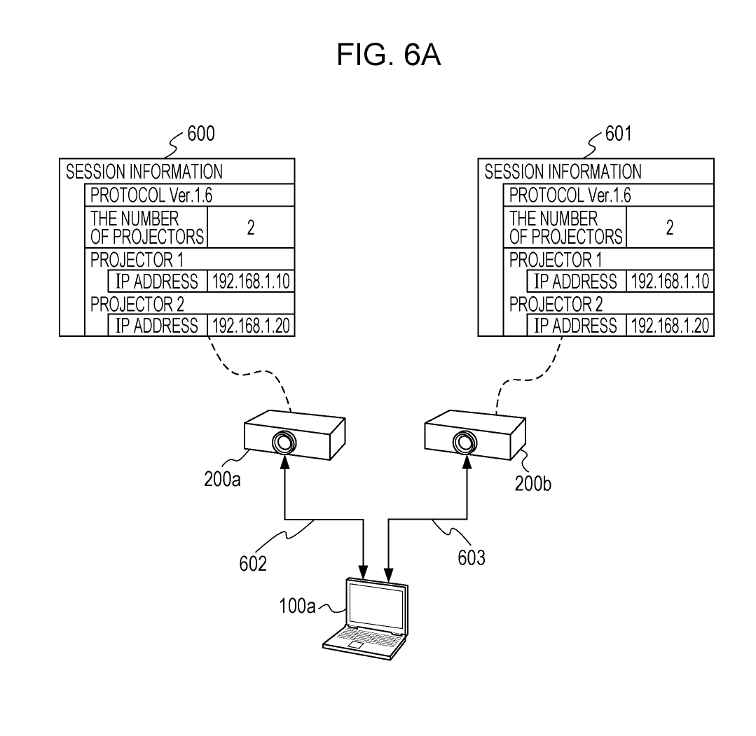

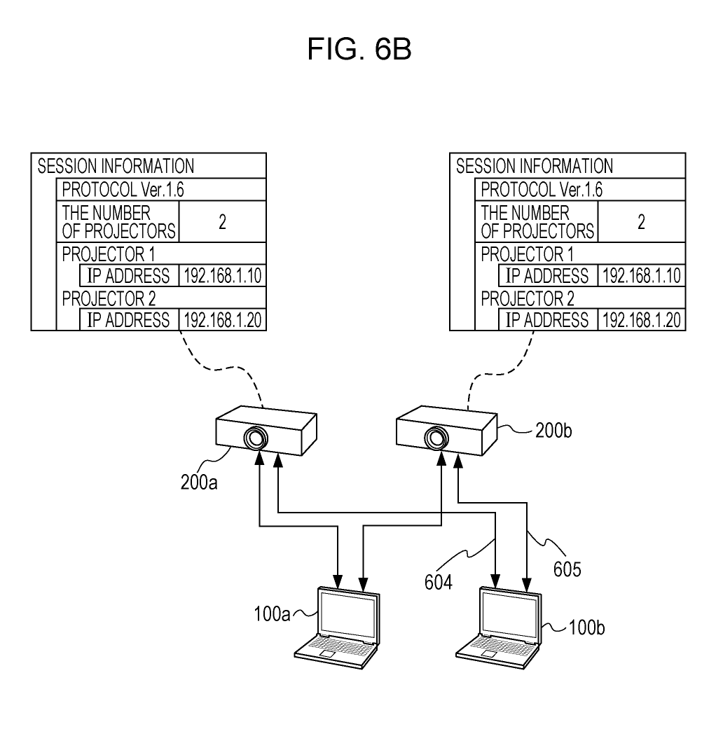

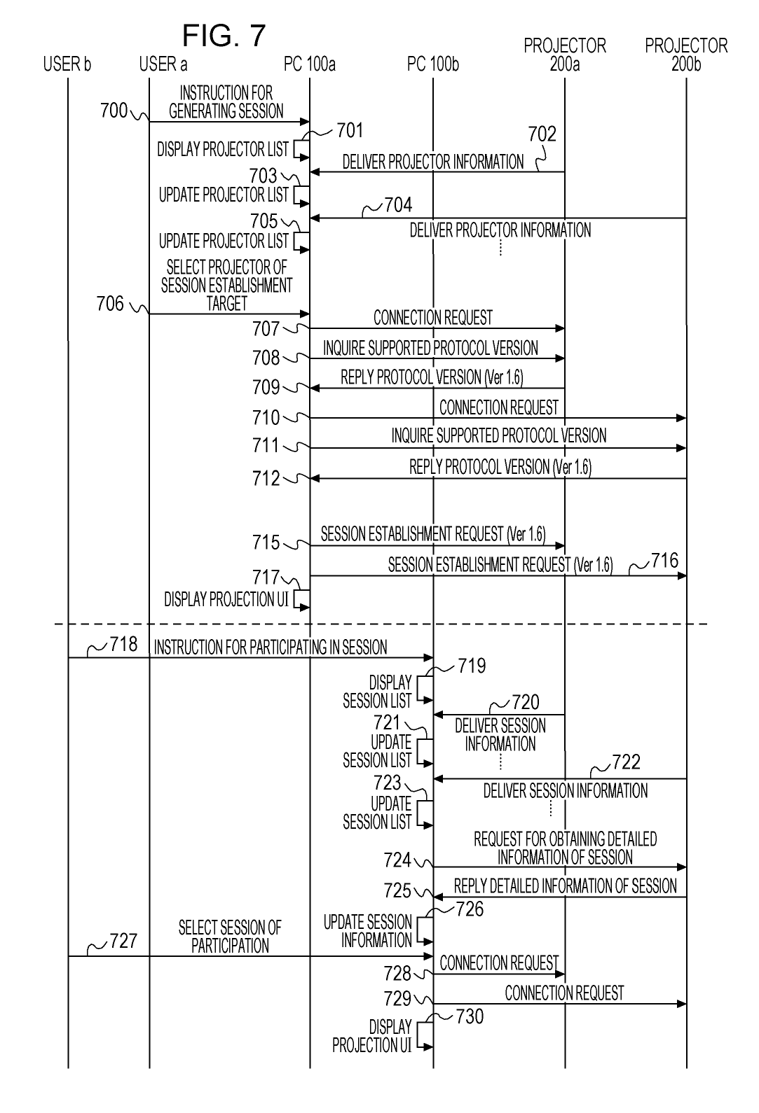

A typical sequence of generation of a session performed by a PC 100a will be described with reference to concept diagrams of session states illustrated in FIG. 6A and a communication sequence illustrated in FIG. 7.

As illustrated in FIG. 6A, a flow of generation of a session among the PC 100a (a PC name of “PC-A”) and projectors 200a and 200b will be described. When a session is successfully generated, a communication path 602 between the PC 100a which has generated the session and the projector 200a and a communication path 603 between the PC 100a and the projector 200b are established as illustrated in FIG. 6A. Furthermore, session information 600 stored in the projector 200a and session information 601 stored in the projector 200b are the same as each other. Here, a version of a communication protocol used in the session, the number of projectors which belong to the session (two in this embodiment), and information on the projectors which belong to the session (IP addresses in this embodiment) are shared as the session information.

A communication sequence of a process of generating the session which involves the projectors 200a and 200b performed by a user an operating the PC 100a will be described with reference to FIG. 7. In FIG. 7, an axis of ordinate denotes an elapsed time, and time elapses downward.

At a timing 700, the user a instructs generation of a new session by operating a GUI application of the PC 100a.

At a timing 701, the GUI application of the PC 100a displays a projector list used for selection of projectors involved in the session. The projector list is generated in accordance with projector information commands broadcasted from projectors through a network 150. Since the projectors 200a and 200b are connected to the network 150 in this embodiment, the projectors 200a and 200b broadcast projector information commands to the network 150 at timings 702 and 704, respectively. The projector information commands at least include IP addresses of the corresponding projectors. The projector information commands may be transmitted once at the timings 702 and 704 and may be transmitted at a predetermined cycle before the session is established.

Since receiving the projector information commands at the timings 702 and 704, the PC 100a updates the projector list at timings 703 and 705. In this embodiment, information on the projector 200a and information on the projector 200b are individually displayed so as to be represented that the projectors 200a and 200b are selectable when a session is generated.

At a timing 706, the user a selects the projectors 200a and 200b from the projector list of the GUI application and instructs generation of a session.

At a timing 707, the GUI application of the PC 100a transmits a connection request so as to establish a logical connection between the PC 100a and the projector 200a which is involved in the session to be generated. When the connection is to be established, authentication by passwords set to the projectors may be required.

At a timing 708, the PC 100a inquires a version of a supported communication protocol to the projector 200a. At a timing 709, the projector 200a transmits a response about the version of the supported communication protocol. In this embodiment, the projector 200a transmits a response representing that the projector 200a supports a protocol version 1.6.

Similarly, at a timing 710, the GUI application of the PC 100a transmits a connection request so as to establish a logical connection between the PC 100a and the projector 200b which is to be involved to by the session to be generated.

At a timing 711, the PC 100a inquires a version of a supported communication protocol to the projector 200b. At a timing 712, the projector 200b transmits a response about the version of the supported communication protocol. In this embodiment, the projector 200b transmits a response representing that the projector 200b supports a protocol version 1.6.

At timings 715 and 716, the PC 100a transmits session establishment request commands to the projectors 200a and 200b which have been connected to the PC 100a, respectively. The session establishment request commands include a name of the session, the number of projectors involved in the session, a protocol version, and information on the projectors involved in the session, and the session establishment request commands transmitted at the timings 715 and 716 store the same information. The projectors 200a and 200b which have received the session establishment request commands enter session established states.

At a timing 717, the PC 100a displays a projection GUI used to perform projection control on the projectors 200a and 200b which are in the session established states.

The process of generating a session is thus completed. Specifically, the projectors 200a and 200b have the respective communication paths to the PC 100a. Furthermore, since the session establishment request commands having the same information are transmitted to the projectors 200a and 200b, the projectors 200a and 200b have the same session information. In this way, an image transfer process may be performed between the PC 100a and the projectors 200a and 200b which are in the session established states and which are connected to the PC 100a.

Next, an operation flow of the second embodiment will be described in detail as a process performed on a PC side and a process performed on a projector side.

FIG. 4B is a flowchart illustrating a process performed by the PC 100a according to the second embodiment. The flowchart of FIG. 4B is executed as a process of the GUI application executed by the PC 100a.

For simplicity of description, the state illustrated in FIG. 6A is taken as a concrete example, and a case where a session is generated by the GUI application of the PC 100a (having the PC name of “PC-A”) with the projector 200a (having a projector name of “Projector 1” and an IP address of “192.168.1.10”) and the projector 200b (having a projector name “Projector 2” and an IP address of “192.168.1.20”) will be described as an example.

When the GUI application is activated in the PC 100a, the GUI application displays a selection UI illustrated in FIG. 8A. The selection UI is used to select generation of a session or participation in a session which has been generated. When a user presses a session generation button 800, the process in FIG. 4B is started.

In step S421, the CPU 101 displays a projector list UI illustrated in FIG. 8B. The projector list US includes a region 802 for displaying information on projectors selectable as session establishment targets. The projector list UI further includes check boxes 803 associated with the region 802, and the user may select at least one projector which is a session establishment target. The projector list UI further includes a scroll bar 804. When a number of projectors which have not been involved in a session are detected, information on all the projectors may be checked by operating the scroll bar 804.

In step S422, the CPU 101 determines whether a projector information command has been received. When the determination is affirmative, the process proceeds to step S423, and otherwise, the process proceeds to step S424. The projector information commands are broadcasted at the timings 702 and 703 of FIG. 7 by projectors which have not been involved by the session. As with the first embodiment, the projector information command has the packet configuration as illustrated in FIG. 9A.

In step S423, the CPU 101 analyzes the received projector information command so as to obtain a projector name and an IP address of the projector, updates display of the projector list UI illustrated in FIG. 8B, and thereafter, the process proceeds to step S424. When the process in step S422 and step S423 is repeatedly performed, information on projectors on the network which have not been involved in the session may be displayed as a list.

Here, if only projector information commands broadcasted by projectors are received, projector information commands supplied from projectors outside a subnetwork are not received, and accordingly, the projectors outside the subnetwork may not be displayed in the projector list UI. To address this problem, a retrieval UI used to directly obtain information on the projectors outside the subnetwork from the projectors by inputting IP addresses of the projectors outside the subnetwork may be embedded in the projector list UI illustrated in FIG. 8B.

In step S424, the CPU 101 waits until the user checks at least one of the check boxes 803 so as to select at least one of the projectors which is a session establishment target and presses an OK button 805. When the selection of the projectors of the session establishment targets is completed, the process proceeds to step S425, and otherwise, the process returns to step S422.

In step S425, the CPU 101 executes a process of connecting to one of the projectors which are determined as the session establishment targets by the user in step S424, and proceeds to step S426. This operation corresponds to establishment of the logical connections to the projectors at timings 707 and 710 of FIG. 7. Although omitted in the communication sequence, when the connection process is performed, as with the first embodiment, a PC information command illustrated in FIG. 9B is transmitted to the projector immediately after the connection is established. A character string stored in the PC name tag 904 may be a computer name which may be obtained from an OS or an arbitrary character string set by the user using the GUI application. In this embodiment, the PC name of “PC-A” of the PC 100a is transmitted to the projector which has been subjected to the connection process as illustrated in FIG. 9B.

In step S426, the CPU 101 determines whether connection to all the projectors specified by the user in step S424 has been completed. When the determination is affirmative, the process proceeds to step S427, and otherwise, the process returns to step S425 where a process of connection to a next one of the projectors specified by the user is executed. The process in step S425 and step S426 will be described taking a state illustrated in FIG. 8B as an example. In FIG. 8B, the user selects two projectors, that is, “Projector 1” and “projector 2” as projectors of session establishment targets. Therefore, the process in step S425 is performed twice in total, that is, the process in step S425 is performed on the projectors named “Projector 1” and “Projector 2”.

A password input field may be included in the region 802 of FIG. 8B for password authentication required for connections to the projectors of the session establishment targets. In this case, communication for the password authentication is performed before the connection request.

In step S427, the CPU 101 obtains projector information commands of the projectors which have established the session so as to collect information.

In step S428, the CPU 101 compares a version of the GUI application which is executing this processing flow with versions of GUI applications of the projectors which have established the session. As a result, when it is determined that at least one of the projectors stores a GUI application of a version newer than the version of the GUI application being executed by the PC 100a, the process proceeds to step S429 where a UI for update of the GUI application illustrated in FIG. 8G is displayed.

In the examples illustrated in FIGS. 9A and 9B, a version of a GUI application of a projector in the tag 930 included in a packet supplied from the projector is 1.1 whereas a version of a GUI application of the PC 100a stored in the ROM 104 is 1.0. Therefore, it is determined that the version of the GUI application of the projector is newer.

In step S430, the CPU 101 determines whether an instruction for updating the GUI application has been issued using the UI for updating a GUI application illustrated in FIG. 8G. When the instruction for updating the GUI application has been issued since the button 840 is pressed, the process proceeds to step S431. When the instruction for updating the GUI application has not been issued since the button 841 is pressed, the process proceeds to step S432.

In step S431, the CPU 101 downloads the GUI application of the new version retrieved in step S428 from the projector which stores the GUI application through the network 150 and the communication unit 109, stores the GUI application in the RAM 102, and proceeds to step S432.

In step S432, the CPU 101 displays a session setting UI illustrated in FIG. 8C. When the user inputs an arbitrary session name in an edit box 806 and presses an OK button 807 in the session setting UI, the process proceeds to step S433.

In step S433, the CPU 101 generates a session establishment request command from the projector information of the session establishment targets and the information input by the user in the session setting in step S432. Thereafter, the CPU 101 transmits the session establishment request command to all the projectors which establish the communication paths in step S425 and proceeds to step S434. The session establishment command corresponds to the commands transmitted from the PC 100a to the projectors 200a and 200b which are the session establishment targets at timings 715 and 716 in FIG. 7.

FIG. 9C is a diagram illustrating a packet configuration of the command which is transmitted from the PC to the projectors which are the session establishment targets.

A command ID tag 905 represents that the command is the session establishment request command.

A session name tag 906 represents a name of a session to be generated.

A numOfPJ tag 907 represents the number of projectors which are session establishment targets.

A protocol version tag 940 represents a version of a communication protocol used in the generated session.

Projector information fields 908 and 909 are provided for individual projectors of the session establishment targets. Each of the projector information fields 908 and 909 includes an IP address tag 910 representing an IP address of a projector of a session establishment target and a PJName tag 911 representing a name of the projector.

When a configuration of the session establishment request command is described taking states of FIGS. 8B and 8C as concrete example, since the user determines a session name as “meeting X” using the UI of FIG. 8C, the session name “meeting X” is stored in the session name tag 906. Since the user has selected the two projectors as the session establishment targets in the UI of FIG. 8B, “2” is stored in the numOfPJ tag 907. Furthermore, in the two projector information fields 908 and 909, IP addresses of the projectors (192.168.1.10 and 192.168.1.20) are stored in the IP address tags 910 and projector names (“Projector 1” and “Projector 2”) are stored in the PJName tags 911 in accordance with the projector information commands received in step S422. The same session establishment request command generated in this way is transmitted to the projectors corresponding to “Projector 1” and “Projector 2”.

In step S434, the CPU 101 displays a projection control UI illustrated in FIG. 8D. The projection control UI includes a session name display area 808, session established projector selection tabs 809 and 810, a MyPC display area 811 for displaying a PC which is activating the GUI application, and a projection layout setting area 812. A method for generating the projection control UI by the GUI application will be described in detail. As described above, since the projectors of “Projector 1” and “Projector 2” have established the session, two tabs of the projectors which have established a session (tabs 809 and 810) are displayed. When the user selects one of the tabs 809 and 810, a projection layout setting area 812 of a projector corresponding to the selected one of the tabs 809 and 810 may be displayed and controlled. These tabs are displayed for individual projectors which are involved in the session. Since the session is named “meeting X” as illustrated in FIG. 8C, the name “meeting X” is displayed in the area 808. In the MyPC display area 811, information representing the PC which is activating the GUI application is displayed. Since only the PC which has generated the session is connected to the projectors which belong to the session immediately after the generation of the session, only the MyPC display area 811 is displayed. Content of the information displayed in the MyPC display area 811 is the same as content of the PC information transmitted to the projectors of the session establishment targets in step S425, that is, “PC-A”. The process performed by the PC when a session is newly generated has been described hereinabove.

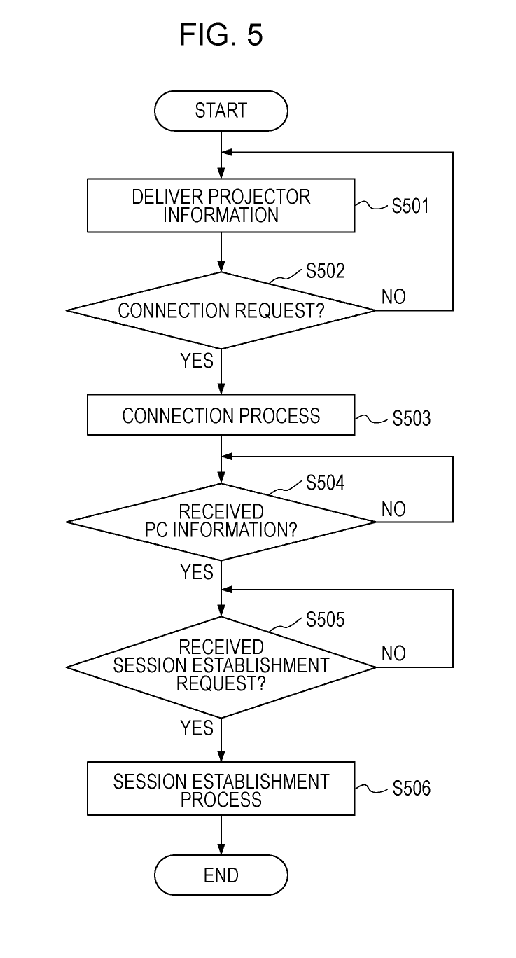

FIG. 5 is a flowchart illustrating a process performed by a projector according to the second embodiment.

First, a process performed by a projector before a session is established will be described. The projector which has not established a session starts the process illustrated in FIG. 5.

In step S501, the CPU 201 broadcasts a projector information command to the network as illustrated at the timings 702 and 704 of FIG. 7 and proceeds to step S502. The projector information command has a packet configuration as illustrated in FIG. 9A as described in step S422 and stores information on the projector which has issued the command. A method for generating the projector information command will be described in detail. The projector which has not established a session obtains an IP address, a projector name, a version of a GUI application, and a version of a communication protocol which are to be stored in the RAM 202 or the ROM 203 of the projector to generate the projector information command. The projector information command is generated by storing the obtained values in the IP address tag 901, the PJ name tag 902, the application version tag 930, and the protocol version tag 931 illustrated in FIG. 9A.

In step S502, the CPU 201 determines whether a request for establishing a logical connection has been received from a PC. When the determination is affirmative, the process proceeds to step S503, and otherwise, the process returns to step S501.

In step S503, the CPU 201 establishes a logical connection to the PC which has issued the connection request in step S502 and proceeds to step S504.

In step S504, the CPU 201 waits for a PC information command which is illustrated in FIG. 9B and which is transmitted from the PC, and proceeds to step S505 when detecting a reception of the command. As described in step S425, the PC information command is transmitted immediately after the PC has established the connection.

In step S505, the CPU 201 waits for a session generation request command which is illustrated in FIG. 9C and which is transmitted from the PC, and proceeds to step S506 when detecting a reception of the command. The session generation request command transmitted by the PC has been described in detail in step S426.

In step S506, the CPU 201 enters a session established state. Here, content of the session generation request command received in step S505 is stored in the RAM 202 as information on a session to which the projector itself belongs. Furthermore, the PC which is a communication partner when the process in step S503 to step S505 is performed is added to a connection PC list stored in the RAM 202 while the PC is associated with the PC information received in step S504. The connection PC list is used to manage PCs which are being connected to the projector.

The process performed by the projector which has not established a session has been described hereinabove. Accordingly, in the process of the projector which has not established a session, the process proceeds using the connection request supplied from the PC in step S502 as a trigger, and when the request from the PC is successfully terminated, the projector enters the session established state.

As described above, in the image transfer system, when a GUI application of a newer version is detected in a projector which is a session establishment target at a time of generation of a session, the user may be prompted to update a GUI application of a PC. By this, the user is not required to check consistency between a GUI application and a projector number and may use a new function of the GUI application by a simple operation.

### Third Embodiment

A third embodiment is different from the second embodiment in that, in a case where a PC participates in a session which has been generated, when a version of a communication protocol of the PC is older than a version of a communication protocol used in the session, a user is prompted to update a GUI application. Configurations of an image transfer system, PCs, and projectors are the same as those of the first and second embodiments, and portions different from the first and second embodiments are mainly described hereinafter.

A typical sequence of participation in a session performed by a PC 100b will be described with reference to the concept diagram of a session state illustrated in FIG. 6B and the communication sequence illustrated in FIG. 7.

As illustrated in FIG. 6B, a flow of a process performed when the PC 100b (PC name of “PC-B”) participates in a session generated by a PC 100a as described in the second embodiment will be described. A communication path 604 between the PC 100b and a projector 200a which is involved in the session and a communication path 605 between the PC 100b and a projector 200b which is involved in the session are established.

A communication sequence of a process of participating in the generated session including the projectors 200a and 200b performed by a user b operating the PC 100b will be described with reference to FIG. 7.

At a timing 718, the user b instructs participation in a session by operating a GUI application.

At a timing 719, the GUI application of the PC 100b displays a session list used to select an available session. The session list is generated in accordance with session information commands broadcasted from projectors which have established a session through a network 150. In this embodiment, as described in the second embodiment, the projectors 200a and 200b establish a session as projectors which belong to the same session. Therefore, the projectors 200a and 200b broadcast session information commands at timings 720 and 722. The session information commands are based on the session request commands transmitted at timings 715 and 716 from the PC which generates the session and includes a session name, the number of projectors involved in the session, and information on the projectors involved in the session. The session information commands may be transmitted once at the timings 720 and 722 and may be transmitted at a predetermined cycle after the session is established.

Since receiving the session information command at the timings 720 and 722, the PC 100b updates the session list at timings 721 and 723. In this embodiment, information on the session generated by the user a as a participation available session (a session name, for example) is displayed. The session information commands transmitted by the projectors 200a and 200b at the timings 720 and 722 are associated with the same session and information on projectors which belong to the session is the same. Accordingly, sessions displayed in the session list are not changed in practice at the timing 723.

At a timing 724, the GUI application of the PC 100b transmits a request for obtaining detailed information on the session to the projector 200b.

At a timing 725, the projector 200b transmits the detailed information on the session to the PC 100b as a response.

At a timing 726, the PC 100b which has received the session detailed information updates session information. Although the session detailed information is requested to the projector 200b in this embodiment, the information may be requested to the projector 200a since projectors included in the same session have the same information as described above.

At a timing 727, the user b selects a session of a participation target from the session list of the GUI application, that is, a session generated by the PC 100a, and instructs participation in the session.

At timings 728 and 729, the GUI application of the PC 100b transmits connection requests so as to establish logical connections between the PC 100b and the projectors 200a and 200b which are to be involved in the session of the participation target. Accordingly, as with the case of the timings 707 and 710, an image transfer process may be performed between the PC 100b and the projectors 200a and 200b which is connected to the PC 100b.

At a timing 730, the PC 100b displays a projection GUI used to perform projection control on the projectors 200a and 200b which are in the session established states.

FIG. 4C is a flowchart illustrating a process performed on a PC side according to the third embodiment. The flowchart of FIG. 4C is executed as a process of the GUI application executed on the PC side.

For simplicity of description, the state illustrated in FIG. 6B is taken as a concrete example, and a case where the GUI application of the PC 100b (having a PC name of “PC-B”) participates in a session which has been generated by the PC 100a (having a PC name of “PC-A”), the projector 200a (having a projector name of “Projector 1” and an IP address of “192.168.1.10”), and the projector 200b (having a projector name “Projector 2” and an IP address of “192.168.1.20”) will be described as an example.

When the GUI application is activated by the PC 100b, the GUI application displays a selection UI illustrated in FIG. 8A. When the user presses a session participation button 801, the process illustrated in FIG. 4C is started.

In step S451, the CPU 101 displays a session list UI illustrated in FIG. 8E. The session list UI includes a region 813 for displaying information on sessions selectable as a participation available session. The session list UI further includes radio buttons 814 associated with the region 813, and the user may select one of the sessions as a participation target using a corresponding one of the radio buttons 814. The session list UI further includes a scroll bar 815, and the user may recognize participation available sessions on the network by list display.

In step S452, the CPU 101 determines whether a session information command has been received. When the determination is affirmative, the process proceeds to step S453, and otherwise, the process proceeds to step S454. The session information commands are broadcasted to the network at the timings 720 and 722 of FIG. 7 by the projectors 200a and 200b which have established the session and have a packet configuration as illustrated in FIG. 9D.

A command ID tag 912 represents that the command is the session information command.

A session name tag 913 represents a name of a session.

A NumOfPJ tag 914 represents the number of projectors involved in the session.

A protocol version tag 950 represents a version of a communication protocol used in the session.

Projector information fields 915 and 916 are provided for individual projectors included in the session. Each of the projector information fields 915 and 916 includes an IP address tag 917 representing an IP address of a corresponding one of the projectors involved in the session and a PJName tag 918 representing a name of the projector.

In step S453, the CPU 101 analyzes the received session information command so as to obtain a session name and updates display of a session list UI illustrated in FIG. 8E, and thereafter, the process proceeds to step S454. When the process in step S452 and step S453 is repeatedly performed, sessions on the network may be displayed as a list. As described in step S423, session information outside a subnetwork is not received. Therefore, a retrieval UI used to directly input an IP address of a projector involved in the session may be provided.

In step S454, the CPU 101 waits until the user selects one of the radio buttons 814 and presses an OK button 817. When the selection of a session of a participation target is completed, the process proceeds to step S455, and otherwise, the process returns to step S452.

In step S455, the CPU 101 compares a version of a communication protocol used in the PC 100b with a version of a communication protocol used in the session. The version of the communication protocol used in the session is set in the tag 950 illustrated in FIG. 9D. Specifically, information in the tag 950 is compared with the version of the communication protocol stored in the RAM 102 of the PC 100b. As a result, when it is determined that the version of the communication protocol used in the PC 100b is older than the version of the communication protocol used in the session, the process proceeds to step S456.

In step S456, the CPU 101 displays a UI for prompting update of a GUI application illustrated in FIG. 8H for a predetermined period of time (approximately 3 seconds), and thereafter, displays a UI for updating the GUI application illustrated in FIG. 8G.

In the examples of FIGS. 9A and 9B, a version of a communication protocol in the projector in the tag 931 is 1.6 and a version of a communication protocol of the PC 100b is 1.5. Therefore, it is determined that the version of the communication protocol of the projector is newer.

In a case where the version of the communication protocol of the PC 100b is not older than the version of the communication protocol used in the session, even if a version of the GUI application of the PC 100b is older than the version used in the session, the GUI application is not updated and the process proceeds to step S459.

In step S457, the CPU 101 determines whether an instruction for updating the GUI application has been issued in the UI for updating a GUI application illustrated in FIG. 8G. When the instruction for updating the GUI application is issued since the button 840 is pressed, the process proceeds to step S458. When the instruction for updating the GUI application is not issued since the button 841 is pressed, the process is terminated.

In step S458, the CPU 101 downloads the GUI application from the projector which stores the communication protocol of the newer version retrieved in step S455 through the network 150 and the communication unit 109, stores the GUI application in the RAM 102, proceeds to step S459.

In step S459, the CPU 101 executes a process of connecting to the projector included in the session selected by the user in step S454 and proceeds to step S460. This operation corresponds to establishment of logical connections to the projectors 200a and 200b at the timings 728 and 729 of FIG. 7. The projector involved in the session is determined from information included in the session information command received in step S452. Although omitted in the communication sequence, when the connection process is performed, a PC information command illustrated in FIG. 9B is transmitted to the projector immediately after the connection is established. In this embodiment, the name “PC-B” of the PC 100b is stored in the PC name tag 904.

In step S460, the CPU 101 determines whether connection to all the projectors involved in the session selected by the user in step S454 has been completed. When the determination is affirmative, the process proceeds to step S461, and otherwise, the process returns to step S459 where a process of connecting to a next one of the projectors involved in the session is executed.

In step S461, the CPU 101 displays a projection control UI illustrated in FIG. 8F. The projection control UI is the same as that illustrated in FIG. 8D which is displayed in the sequence of generation of a session by the PC 100a in the second embodiment. However, in the sequence of this embodiment, the UI is obtained after the PC 100b completes participation in the generated session. Therefore, the name “PC-B” of the PC 100b is displayed in a MyPC display area 818 representing a PC which is activating the GUI application. Furthermore, the name “PC-A” of the PC 100a which generated the session is displayed in a connection PC list 819 representing a list of PCs being connected to the session other than the PC 100b.

As described above, in an image transfer system, in a case where a PC participates in a session which has been generated, when a version of a communication protocol of the PC is older than a version of a communication protocol used in the session, a user is prompted to update a GUI application of the PC. By this, the user is not required to check consistency between the GUI application and a projector number and may use a new function of the GUI application by a simple operation. The plurality of embodiments which are different from one another in terms of timings of checking of versions are described hereinabove. The present invention is not limited to these embodiments.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-108244, filed, May 26, 2014, which is hereby incorporated by reference herein in its entirety.

What is claimed is:

1. An information processing apparatus capable of communicating with a plurality of projectors through a network, the information processing apparatus comprising:
a storage unit configured to store a projection program used to control a projection process performed by the projectors through the network;
a first obtaining unit configured to obtain version information of a projection program stored in at least one of the projectors connected to the network; and
a determination unit configured to determine a projection program included in one of the projectors connected to the network so as to update the projection program stored in the storage unit in accordance with the version information obtained by the first obtaining unit and version information of the projection program stored in the storage unit.

2. The information processing apparatus according to claim 1, wherein
the determination unit determines that the projection program is obtained from at least one of the projectors which stores a projection program of a version which is newer than the version of the projection program stored in the storage unit from among versions represented by the version information obtained by the first obtaining unit.

3. The information processing apparatus according to claim 1, further comprising:
a second obtaining unit configured to obtain version information of a projection program used in a network group when the network group is formed,
wherein, when the version information is obtained by the second obtaining unit, the determination unit determines a projection program to be obtained from among projection programs stored in the projectors connected to the network in accordance with the version information obtained by the second obtaining unit and the version information of the projection program stored in the storage unit.

4. The information processing apparatus according to claim 3, wherein
the determination unit determines that the projection program is obtained from one of the projectors which stores a projection program of a version which is the same as a version represented by the version information obtained by the second obtaining unit.

5. The information processing apparatus according to claim 1, further comprising:
a second obtaining unit configured to obtain version information of a projection program used in a generated network group when the information processing apparatus belongs to the generated network group,
wherein, when the version information is obtained by the second obtaining unit, the determination unit determines a projection program to be obtained from among projection programs stored in the projectors connected to the network in accordance with the version information obtained by the second obtaining unit and the version information of the projection program stored in the storage unit.

6. The information processing apparatus according to claim 5, wherein
the determination unit determines that the projection program is obtained from one of the projectors which stores a projection program of a version which is the same as a version represented by the version information obtained by the second obtaining unit.

7. The information processing apparatus according to claim 1 which provides a user interface used to control layout of projection performed by at least one of the projectors connected to the network using the projection program.

8. The information processing apparatus according to claim 1 which provides a user interface used to control transmission or stop of transmission of an image to the projectors connected to the network from the information processing apparatus using the projection program.

9. A method for controlling an information processing apparatus which is capable of communicating with a plurality of projectors through a network and which stores a projection program used to control a projection process of the projectors through the network, the method comprising:
obtaining version information of a projection program stored in at least one of the projectors connected to the network; and
determining a projection program included in one of the projectors connected to the network so as to update the projection program stored in the information processing apparatus in accordance with the obtained version information and version information of the projection program stored in the information processing apparatus.

10. A computer-readable storage medium storing instructions that, when executed by a computer, cause the computer to perform the method of claim 9.
